(19) United States
(12) Patent Application Publication
(10) Pub. No.: US 2018/0264548 A1
(43) Pub. Date: Sep. 20, 2018

(54) Silver Coated Copper Flakes and Methods of Their Manufacture

(71) Applicant: CLARKSON UNIVERSITY, Potsdam, NY (US)

(72) Inventors: Dan V. Goia, Potsdam, NY (US); Corina Goia, Potsdam, NY (US); John I. Njagi, Potsdam, NY (US)

(21) Appl. No.: 15/542,174

(22) PCT Filed: Jan. 6, 2016
(86) PCT No.: PCT/US2016/012299

§ 371 Date: Jul. 7, 2017

Related U.S. Application Data
(60) Provisional application No. 62/101,447, filed on Jan. 9, 2015.

(51) Int. Cl. B22F 1/02; C23C 18/44; C23C 18/16; C23C 18/54; B22F 1/00

(52) U.S. Cl. CPC B22F 1/025; C23C 18/44; C23C 18/1637; C23C 18/1651; C23C 18/1692; H01B 1/026; B22F 1/0088; B22F 1/0055; B22F 1/0062; B22F 2999/00; C23C 18/54

(57) ABSTRACT

Compositions having copper flakes coated with silver, where the silver is present as a hermetically closed metal shell around the copper, are described. The hermetically closed metal shell can limit oxidation of copper for at least 365 days at a temperature of less than 100° C. The composition can also contain palladium in an amount of about 1% or less by weight of silver in the shell. Palladium limits the migration of copper from the core flakes to the silver shell at temperatures below 250° C. Methods of manufacturing copper flakes coated can include the steps of treating copper flakes with an acid to form acid treated copper flakes, treating the acid treated copper flakes with a polyamine to form polyamine treated copper flakes, depositing silver on the polyamine treated copper flakes to form copper flakes comprising silver deposits, and depositing silver onto the copper flakes comprising silver deposits.

### FIELD OF THE INVENTION

The present invention relates to silver coated copper flakes and methods of manufacturing such flakes.

### BACKGROUND OF THE INVENTION

The electronic industry has been trying for many decades to replace silver with less expensive conductive materials having comparable electrical and chemical properties. Most solutions developed involved coating some of the most frequently used substrate materials with silver in ‘platy’ particulate substrates having suitable size, size distribution, and morphology for the intended application.

Copper is an excellent choice as a substrate for Ag coating. It can be ‘worked’ mechanically into flakes with sizes and aspect ratios similar to those of silver flakes. It also has an electrical conductivity comparable to that of silver. However, the biggest disadvantage of copper is its propensity to easily oxidize and react with components of the thick film paste and with atmospheric oxygen once converted in electrically conductive tracks. As a result, the electrical properties of the latter are degrading in time causing reliability issues. This shortcoming could be eliminated by encapsulating the copper flakes within a continuous silver shell.

The effective encapsulation of the copper flakes in liquid dispersions is hindered by problems related both to the properties of copper surface and the process used for depositing the silver shell onto the copper surface. With regard to the properties of the copper surface, most copper flakes tend to have a stressed surface due to the mechanical action during milling. Topographic and energetic inhomogeneities cause difficulty in achieving an epitaxial deposition of silver, which is essential for obtaining a continuous metallic shell. For this reason, the electroless methods have had limited success when attempted directly on the copper surface. The residual lubricant from the milling/flaking process further limits or prevents the formation of an adherent and continuous silver coating. To date, the most successful industrial approach to coat copper flakes with silver has been through electrodisplacement. Unfortunately, this route can never achieve pore-free silver shells as the displacement process necessarily requires the presence of exposed copper. The major problem related to the deposition of silver onto copper is the competition that exists between the copper core and any dedicated reducing agent to donate electrons to the silver ions. The relatively large redox potential gap between the Ag⁺/Ag⁰ and Cu²⁺/Cu⁰ systems (0.46 V) ensures that electrodisplacement (and thus copper dissolution) will always accompany the silver plating.

### SUMMARY OF THE INVENTION

In one aspect, the invention relates to compositions comprising one or more copper flakes coated with silver, wherein the silver is present as a hermetically closed metal shell around the copper.

In another aspect, the invention relates to a method of manufacturing copper flakes coated with silver where the method comprises treating copper flakes with an acid to form acid treated copper flakes, treating the acid treated copper flakes with a polyamine to form polyamine treated copper flakes, depositing silver on the polyamine treated copper flakes to form copper flakes comprising silver deposits, and depositing silver onto the copper flakes comprising silver deposits.

### BRIEF DESCRIPTION OF THE DRAWINGS

The invention may be understood from the following detailed description when read in connection with the accompanying drawings.

FIGS. 1a and 1b are schematic representations of the displacement step and the electroless plating step in depositing silver on copper flakes.

FIGS. 2a and 2b are SEM images at magnifications of 10,000 and 100,000, respectively, of copper flakes with silver on the surface produced using triethylenetetramine (TETA).

FIGS. 3a and 3b are SEM images at magnifications of 10,000 and 100,000, respectively, of copper flakes with silver on the surface produced using tetraethylenepentamine (TEPA).

FIGS. 4a and 4b are SEM images at magnifications of 10,000 and 100,000, respectively, of copper flakes with silver on the surface produced using a mixture of triethylenetetramine (TETA) and ethylenediamine (EDA) in a ratio 80/20 by weight.

FIG. 5 is a graph of the results of thermal gravimetric analysis (TGA) over the temperature range of 100° C. to 600° C. of copper flakes containing silver produced using TETA, TEPA and a mixture of TETA and EDA.

FIG. 6 is a graph of the results of thermal gravimetric analysis (TGA) over the temperature range of about 75° C. to about 270° C. of copper flakes containing silver produced using TETA, TEPA and a mixture of TETA and EDA.

FIGS. 7a and 7b are FESEM images at magnifications of 10,000 and 100,000, respectively, of copper flakes with silver on the surface produced without the use of a dispersing agent.

FIGS. 8a and 8b are FESEM images at magnifications of 10,000 and 100,000, respectively, of copper flakes with silver on the surface produced using Daxad as a dispersing agent.

FIGS. 9a and 9b are FESEM images at magnifications of 10,000 and 100,000, respectively, of copper flakes with silver on the surface produced using Arabic gum as a dispersing agent.

FIG. 10 is a graph of the results of thermal gravimetric analysis (TGA) over the temperature range of 100° C. to 600° C. of copper flakes containing silver produced without the use of a dispersing agent and with the use of Daxad or Arabic gum as a dispersing agent.

FIG. 11 is a graph of the results of thermal gravimetric analysis (TGA) over the temperature range of about 90° C. to about 245° C. of copper flakes containing silver produced without the use of a dispersing agent and with the use of Daxad or Arabic gum as a dispersing agent.

FIGS. 12a and 12b are FESEM images at a magnification of 100,000, of copper flakes with silver deposited on the surface after electroless plating using: (a) TEPA alone and (b) an 80:20 mixture of TETA and EDA.

FIGS. 13a-13d are FESEM images at a magnification of 100,000, of copper flakes with silver on the surface produced: (a) without the use of Pd, (b) using 0.1% Pd, (c) using 0.5% Pd, and (d) using 1.0% Pd.

FIG. 14 is a graph of the results of thermal gravimetric analysis (TGA) over the temperature range of about 50° C. to about 600° C. of copper flakes containing silver produced: (a) without the use of Pd, (b) using 0.1% Pd, (c) using 0.5% Pd, and (d) using 1.0% Pd.

### DETAILED DESCRIPTION OF THE INVENTION

As used in this specification and the appended claims, the singular forms “a”, “an” and “the” include plural referents unless the context clearly indicates otherwise. Thus, for example, reference to “a catalyst” includes a mixture of two or more catalysts, and the like.

As used herein, the term “about” means approximately and refers to a range that is optionally ±25%, preferably ±10%, more preferably, ±5%, or most preferably ±1% of the value with which the term is associated.

When a range, or ranges, for various numerical elements are provided, the range, or ranges, include the values, unless otherwise specified.

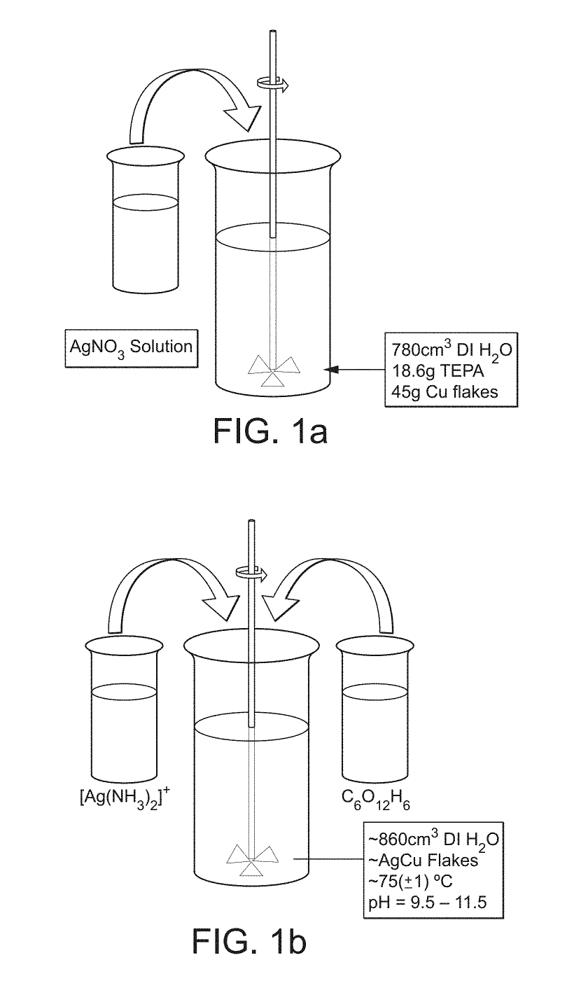

A method of manufacturing copper flakes coated with silver comprises cleaning the surface of the copper flakes and depositing silver on the flakes to form a hermetically closed silver shell over the copper flakes. The hermetically closed silver shell is pore free. Lubricants, such as fatty acids, are used in the production of copper flakes. Copper oxides may also be present in or on the copper flakes. Cleaning the surface of the copper flakes comprises: (a) treating copper flakes with an acid to form acid treated copper flakes, and (b) treating the acid treated copper flakes with a polyamine to form polyamine treated copper flakes. Depositing silver on the cleaned flakes to form a hermetically closed silver shell over the copper flakes is performed using two sequential procedures: electrodisplacement (step (c)) and electroless plating (step (d)). Electrodisplacement, shown schematically in FIG. 1a, results in the formation of a thin silver base layer with discontinuities on the surface of the copper flakes. The base layer does not form a coating over the entire copper flake. This step deposits silver on the polyamine treated copper flakes to form copper flakes comprising silver deposits. The displacement reaction is shown below.

2Ag⁺+Cu⁰→2Ag⁰+Cu²⁺

Electroless plating, shown schematically in FIG. 1b, fills in the discontinuities in the silver base layer and forms a hermetically closed metal shell comprising silver around the copper. This step deposits silver onto the copper flakes comprising silver deposits as formed by displacement, as described above. Electroless plating involves three reactions that work together to form the electroless plating reaction as shown below:

C₆H₁₂O₆+6OH⁻→6HCOOH+12e⁻+6H⁺

12Ag⁺+24NH₃→12[Ag(NH₃)₂]⁺

12[Ag(NH₃)₂]⁺+12e⁻→12Ag⁰+24NH₃

C₆H₁₂O₆+12Ag⁺+6OH⁻→12Ag⁰+6H⁺+6HCOOH

Step (a) dissolves copper oxides and dislodges lubricant from the surface of copper flakes by treating the copper flakes with a solution comprising an acid that can dissolve copper oxides. The acid is preferably nitric acid. Step (a) is preferably performed using a solution comprising an alcohol to dissolve the displaced lubricant. The alcohol preferably contains 1-6 carbons, and preferably is methanol, ethanol or propanol, or mixtures thereof. The solution comprising the acid is mixed with the copper flakes, then the copper flakes are separated from the acid solution.

Step (b) provides for the dissolution of copper oxides and protects the copper surface from oxidation at alkaline pH (typically >8). Copper flakes that had been treated with the acid are then treated at least twice with an aqueous solution of a polyamine. The polyamine can comprise a long chain linear amine or a mixture of linear polyamine with short chain and long chain lengths groups. A long chain linear amine is an amine comprising 3-6 amine groups, preferably connected through ethylene groups. A short chain amine comprises 1-2 amine groups. Examples of polyamines that can be used include triethylenetetramine (TETA), tetraethylenepentamine (TEPA), a mixture of triethylenetetramine (TETA) and ethylenediamine (EDA), diethylenetriamine (DETA) and pentaethylenehexamine (PEHA). Preferably the polyamine is pentaethylenehexamine (PEHA) or a mixture of triethylenetetramine (TETA) and ethylenediamine (EDA). The mixture of TETA/EDA is preferably in a ratio 80/20 by weight. After each treatment, the aqueous solution is removed from the copper flakes.

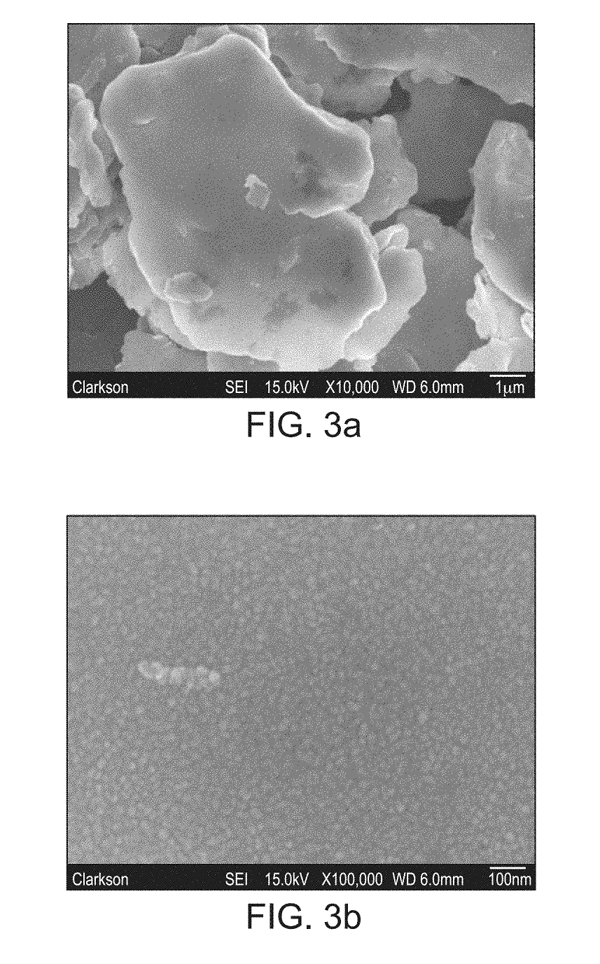

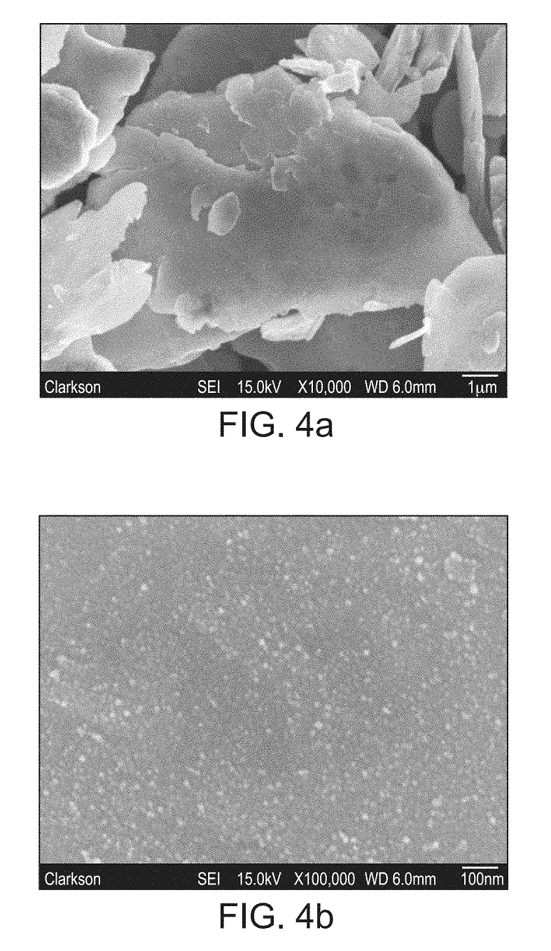

Encapsulation of copper flakes with a continuous adherent silver shell requires not only the removal superficial copper oxides and lubricants left from the milling process, but also limiting or preventing the re-formation of copper oxides on the surface. Limiting or preventing the re-formation of copper oxides on the surface is essential when the pH of the displacement or silver plating systems is above the value at which the hydrolysis of cuprous and cupric ions is possible (>4.0). Compounds that form stable soluble complexes with cuprous and cupric ions and contain functional groups with high affinity for the native Cu⁰ surface are typically used for this purpose. Amines with different structures have been frequently used. The inventors have discovered that using a long chain linear amine or, even better, a mixture of linear polyamines with short and long chain length in the cleaning and electrodisplacement steps results in a more continuous silver layer. Triethylenepentaamine (TEPA) by itself and a 1:4 mixture of ethylenediamine (EDA) and triethylenepentaamine (TEPA) provide the most continuous silver layer (FIGS. 3 and 4).

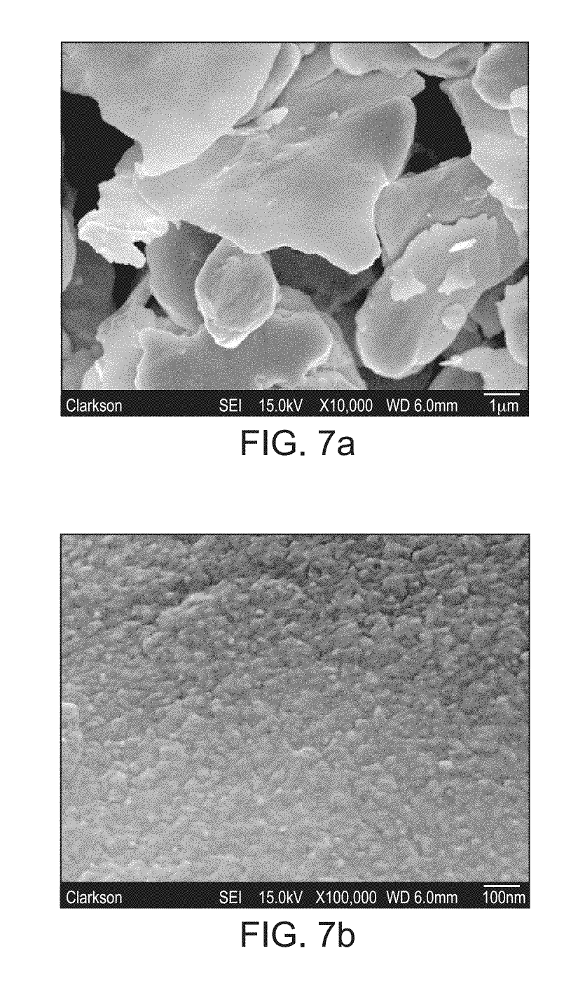

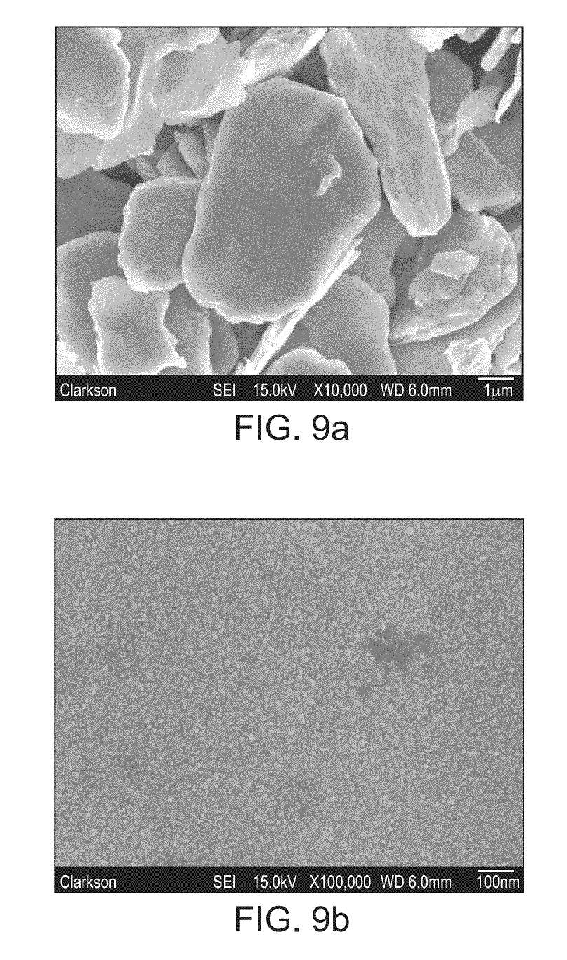

Step (c) deposits silver on the polyamine treated copper flakes to form copper flakes in which particles of silver partially coat the surface of the copper. The step can be performed by electrodisplacement. An aqueous solution of a silver salt is added to a mixture of the copper flakes, a polyamine (as described above) and a dispersant. The silver salt is preferably silver nitrate. The water used to prepare the aqueous solution of the silver salt is preferably deionized water or distilled water. Preferable dispersing agents are DAXAD 11D, arabic gum, polyvinylpyrrolidone/PVP and sodium alginate. The use of a dispersing agent, such as arabic gum or Daxad, in the electrodisplacement step provides a silver base layer having fewer discontinuities. By facilitating the formation of a larger number of silver nucleation centers on the surface of the copper flakes, the dispersing agent provides a more continuous and uniform silver layer which covers more extensively the surface of the copper substrate. This effect can be observed by the color of the final AgCu flakes and high resolution FESEM images of the surface. AgCu flakes formed by electrodisplacement without a dispersant had a reddish color, indicating a larger area of exposed copper surface compared to AgCu flakes formed by electrodisplacement with 0.2% Arabic gum as a dispersant. FIG. 7 shows FESEM images of a AgCu surface formed after displacement without a dispersant present. FIG. 9 shows FESEM images of a AgCu surface formed after displacement with 0.2% Arabic gum (based on the silver reduced) added as a dispersant. The grain size of the silver was reduced by an order of magnitude in the presence of dispersant. The solution of the silver salt is added to the mixture comprising the copper flakes with stirring. Preferably the addition is performed continuously over a period of about 3-10 minutes, more preferably over about 8 minutes.

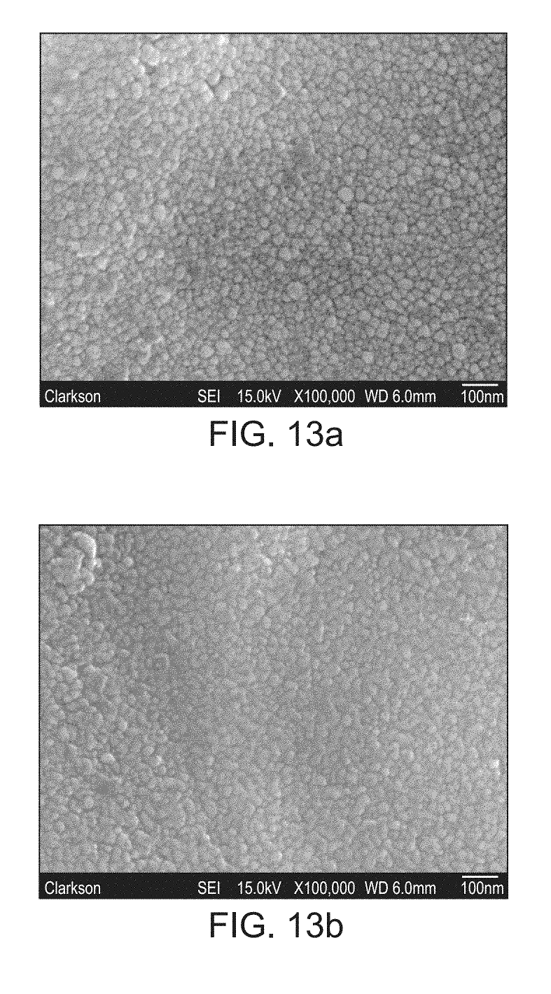

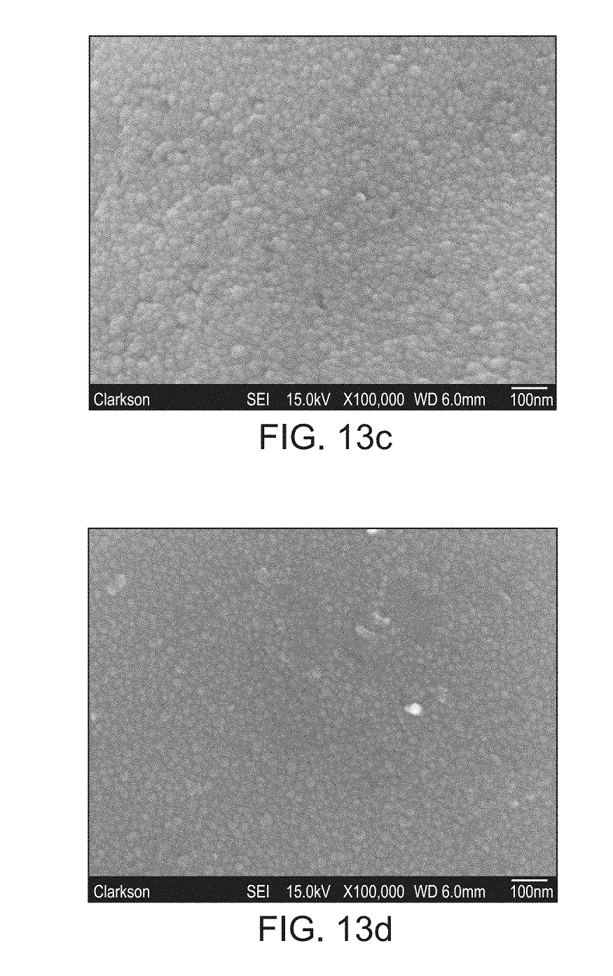

The addition of a small amount of palladium (0.1-1.0% by weight) as palladium nitrate in the silver nitrate solution used in the electrodisplacement step provides several benefits. Since Pd²⁺ ions are more electropositive than Ag⁺ ions, they are reduced more rapidly by copper and form a larger number of nucleation centers on which the silver is reduced. This leads to a larger number of smaller silver crystallites that translate in a thinner but more complete coverage of the copper core. FIG. 13a shows a FESEM image of a silver layer deposited in a displacement reaction without palladium present. FIG. 13d shows a FESEM image of a silver layer deposited in a displacement reaction with 1.0% Pd in the silver nitrate solution during the displacement reaction.

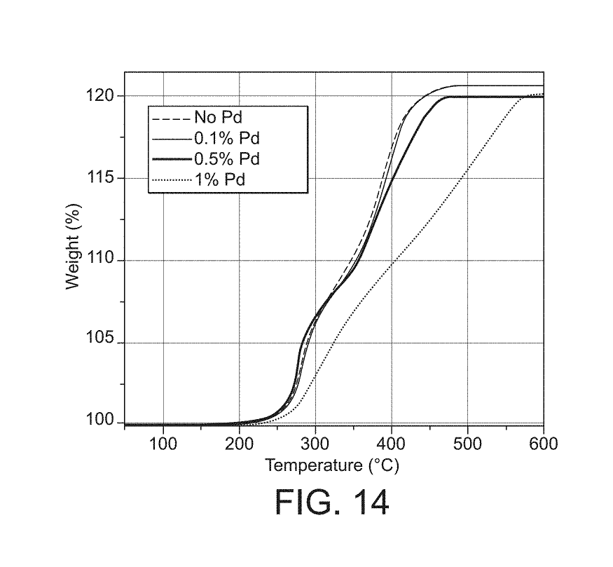

Pd is an effective plating catalyst and its presence in the silver facilitates an improved deposition of additional silver during the subsequent electroless plating. The presence of Pd in the silver matrix is known to reduce silver migration and concomitantly the diffusion of copper atoms through the silver shell. FIG. 14 shows the effect of palladium addition on the oxidation pattern of AgCu flakes without palladium and with various amount of palladium.

Reduced silver migration in the base layer produced in step (c) by displacement provides also the possibility to heat treat the final AgCu flakes to improve the continuity and electrical properties of the final external silver shell. The presence of palladium in the silver deposited on the copper flakes in step (c) allows these AgCu flakes to be heated to a temperature ˜40° C. higher than the temperature used during heat treatment of copper flakes without palladium without experiencing copper diffusion to the surface.

Step (d) deposits silver on the copper flakes having silver deposits formed in step (c). Step (d) can be performed by electroless plating. A solution of a silver salt is added with vigorous stirring to a mixture of the copper flakes containing silver, as formed in step (c), while a solution of a reducing agent is also added to the mixture of the copper flakes. Preferably the solution of the silver salt comprises the diamminesilver ion ([Ag(NH₃)₂]⁺), which can be prepared by mixing a solution of a silver salt, such as silver nitrate, with a solution of ammonium hydroxide. The reducing agent can be a sugar, preferably dextrose or glucose. The mixture of the copper flakes is heated to an elevated temperature of about 75° C.±10° C.) during the addition of the solution containing the diamminesilver ion and the solution containing the dispersant. Preferably, each of the solutions containing the diamminesilver ion and the dispersant are also at a temperature of about 75° C. during the addition of these solutions to the mixture comprising the copper flakes containing silver as formed in step (c). The rate of addition of the silver salt is controlled and is a preferably added at a rate of greater than 100 minutes. After the addition of the two solutions, the copper flakes are washed with deionized or distilled water, then with an alcohol, preferably methanol or ethanol, and then dried, preferably at an elevated temperature, more preferably at a temperature of about 95° C. Other drying methods that prevent the oxidation of copper can be used.

The inventors have discovered that by adding the solutions of silver ammonia and dextrose separately, but at the same time, over a period of about 2 hours to the mixture of the silver containing copper flakes at ˜75° C., the silver is deposited uniformly forming a continuous and uniform encapsulating shell.

A composition comprises one or more copper flakes coated with silver, where the silver is present in a hermetically closed metal shell around the copper. The silver metal shell can be pore free. The hermetically closed metal shell can limit the oxidation of copper over a period of at least 365 days at a temperature of less than 100° C. Copper flakes in the composition do not oxidize until they reach a temperature of at least 200° C. The hermetically closed metal shell can limit the migration of copper from the core flakes to the silver shell at temperatures below 250° C.

The average grain size of silver in the deposited layer can be about 40 nm or less, preferably about 15 nm or less, as measured by Field Emission Scanning Electron Microscopy (FESEM).

The composition can further comprise palladium in an amount of about 1% or less by weight of silver in the shell. When palladium is present in an amount of about 1% or less by weight of silver in the shell, the hermetically closed metal shell can limit the oxidation of copper over a period of at least 365 days at a temperature of less than 100° C. When palladium is present in an amount of about 1% or less by weight of silver in the shell, the hermetically closed metal shell can limit the migration of copper from the core flakes to the silver shell at temperatures below 250° C.

When copper flakes coated with silver present in a hermetically closed metal shell around the copper were placed in a 1M nitric acid solution, a blue color did not appear. This shows that the copper is not accessible to be dissolved by the acid and that the silver shell over the copper flakes is hermetically closed.

The silver coated copper flakes described herein can be used as replacement for silver flakes in conductive pastes for non-fired electronic applications, such as membrane touch switches, conductive adhesives, polymer thick film, and EMI shielding.

### EXAMPLES

### Surface Cleaning

Surface cleaning of copper flakes was performed in a 600 cm³ beaker and comprised two steps: (a) an acid rinse followed by (b) an amine treatment.

First, 250 cm³ of EtOH and 1.1 cm³ of 67% HNO₃ (in this order) were mixed in the reaction vessel. Next, 90 g of copper flakes were dispersed in the solution and mixed for 15 min at 600 rpm. The mixing was stopped and the copper flakes were allowed to settle for about 45 min before the solution over the flakes was removed by decanting the solution from the copper or by filtering copper from the solution.

After decanting the solution, 230 cm³ of deionized water (DI H₂O) and 4.5 g of an amine ((Example 1—triethylenetetraamine (TETA); Example 2—(tetraethylenepentamine (TEPA); and Example 3—80:20 mixture of TETA/EDA (ethylenediamine)) were added to the copper flakes and the dispersion was mixed for 15 min at 1500 rpm. The mixing was stopped and the copper flakes were allowed to settle for about 45 min before the solution over the flakes was removed by decanting the solution from the copper.

### Displacement Reaction

The displacement reactions were carried out in a 2 dm³ beaker with vigorous mixing (medium propeller at 1900 rpm).

A solution of a dispersant (0.5 g Daxad 11G or 0.5% Arabic gum) and 18.6 g of the amine used in surface cleaning the copper (TETA, TEPA or the mixture of TETA/EDA) were added to 780 cm³ DI H₂O. Wet copper flakes (cleaned as described above under Surface Cleaning) were then added to this solution with vigorous mixing.

An amount of 10.75 g of AgNO₃ (6.8 g Ag) dissolved in 60 cm³ of DI H₂O was added to the mixture of a dispersant, an amine and the cleaned copper flakes at a rate of about 7.5 cm³/min.

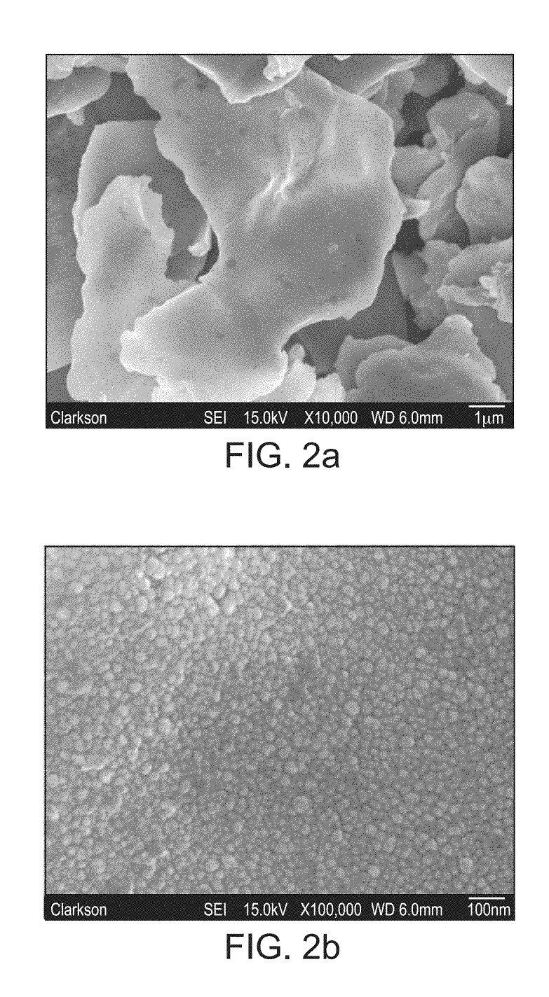

Samples of the copper flakes containing silver nanoparticles were analyzed by SEM taken with a field emission electron microscope to determine size of the silver nanoparticles deposited on the copper flakes. FIGS. 2a and 2b are SEM images at magnifications of 10,000 and 100,000, respectively, of copper flakes with silver on the surface produced using triethylenetetramine (TETA). FIGS. 3a and 3b are SEM images at magnifications of 10,000 and 100,000, respectively, of copper flakes with silver on the surface produced using tetraethylenepentamine (TEPA). FIGS. 4a and 4b are SEM images at magnifications of 10,000 and 100,000, respectively, of copper flakes with silver on the surface produced using a mixture of triethylenetetramine (TETA) and ethylenediamine (EDA) in a ratio 80/20 by weight. A comparison of these figures shows that TEPA provides smaller silver clusters that TETA and that the combination of 80% TETA and 20% EDA provides the most continuous silver layer and the smallest silver clusters.

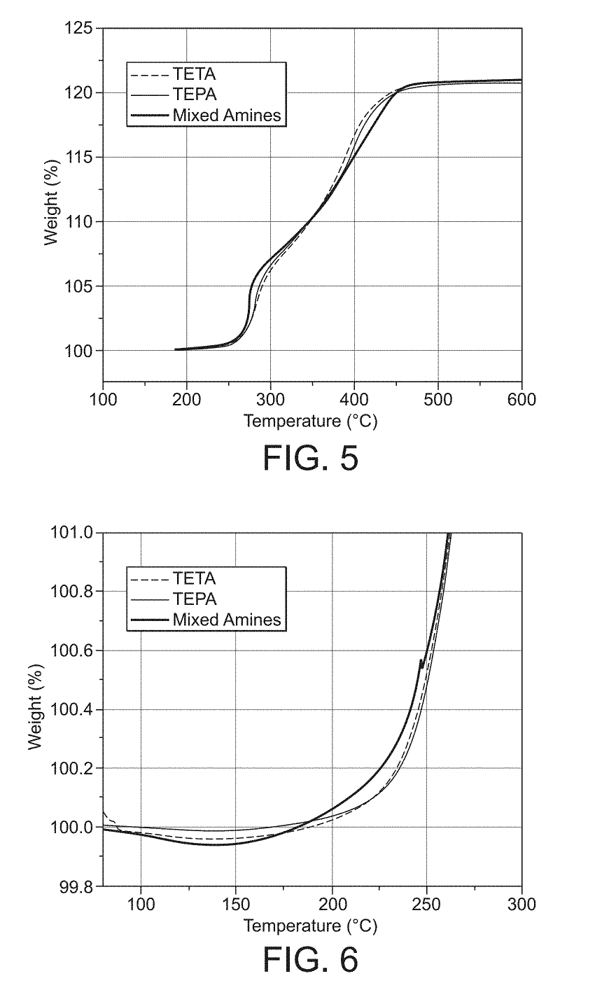

Samples of the copper flakes containing silver nanoparticles were analyzed by TGA to study the oxidation of flakes be evaluating the dynamics of weight gain during heating. FIG. 5 is a graph of the results of thermal gravimetric analysis (TGA) over the temperature range of 100° C. to 600° C. of copper flakes containing silver produced using TETA, TEPA and a mixture of TETA and EDA. FIG. 6 is a graph of the results of thermal gravimetric analysis (TGA) over the temperature range of about 75° C. to about 270° C. of copper flakes containing silver produced using TETA, TEPA and a mixture of TETA and EDA. These figures indicate that there are only subtle differences in the oxidation pattern using the different amines. TETA appears to provide the largest delay in the onset of oxidation, while the mixture of TETA and EDA provides a beneficial effect at temperatures of about 400° C.

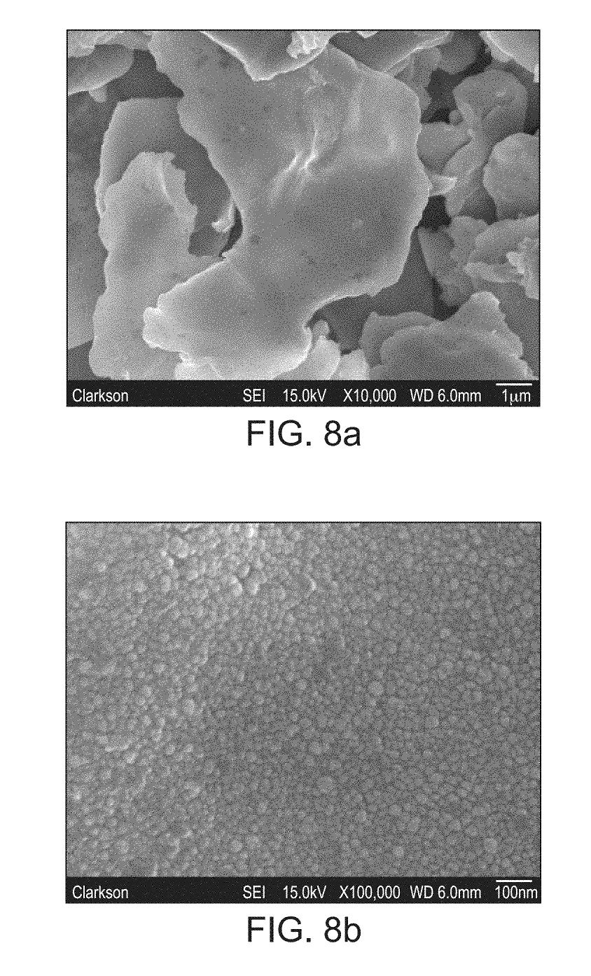

FIGS. 7a and 7b are FESEM images at magnifications of 10,000 and 100,000, respectively, of copper flakes with silver on the surface produced without the use of a dispersing agent. FIGS. 8a and 8b are FESEM images at magnifications of 10,000 and 100,000, respectively, of copper flakes with silver on the surface produced using Daxad as a dispersing agent. FIGS. 9a and 9b are FESEM images at magnifications of 10,000 and 100,000, respectively, of copper flakes with silver on the surface produced using Arabic gum as a dispersing agent. A comparison of these figures show that the use of a dispersant resulted in smaller sized silver particles being deposited on the flakes compared to when a dispersant was not used. Daxad 11G provided smaller size silver particles (average size about 40 nm) than those formed without a dispersant, while arabic gum provided the smallest size silver particles (average size about 15 nm).

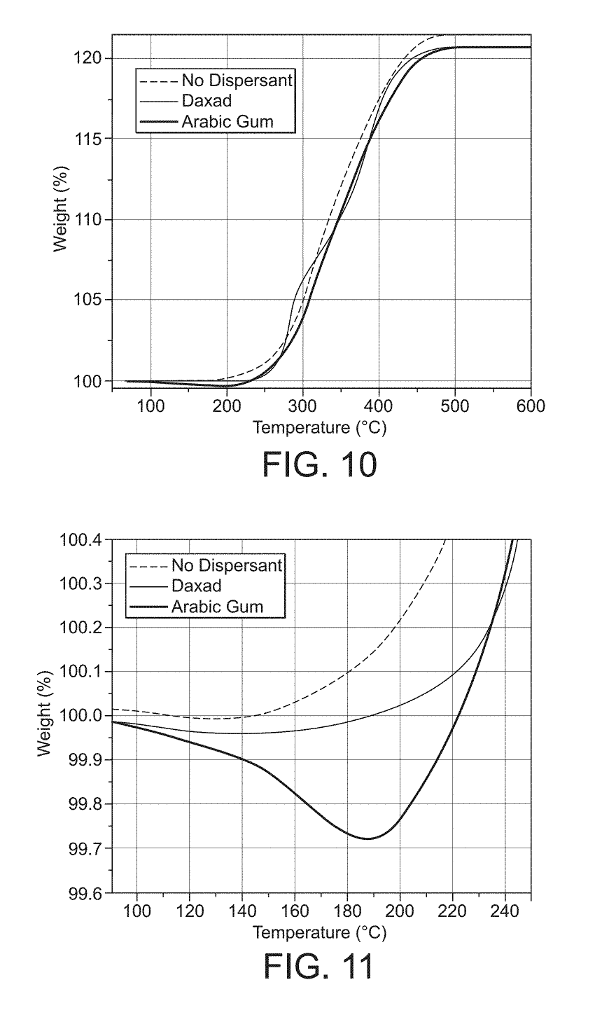

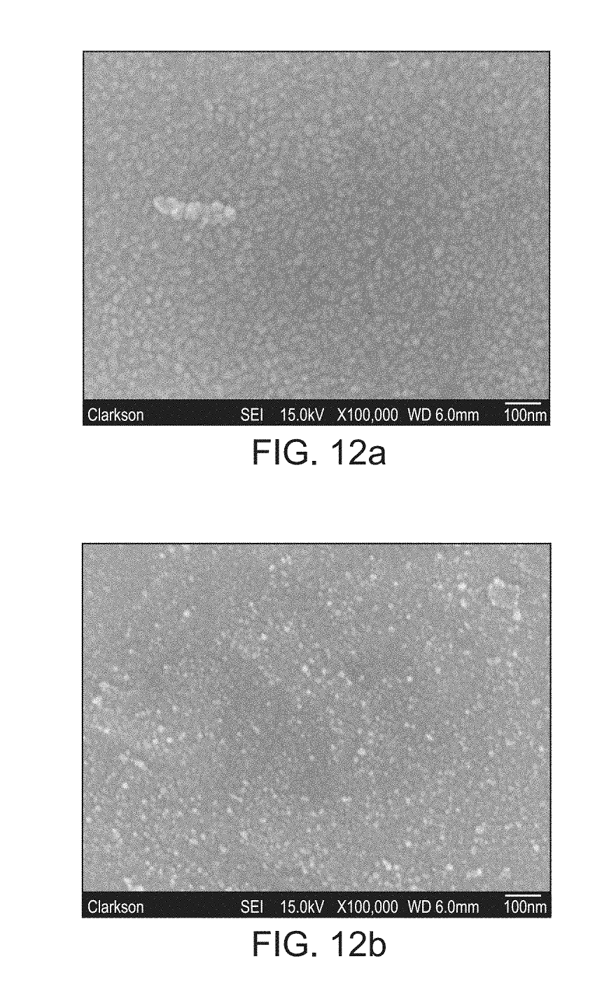

FIG. 10 is a graph of the results of thermal gravimetric analysis (TGA) over the temperature range of 100° C. to 600° C. of copper flakes containing silver produced without the use of a dispersing agent and with the use of Daxad or Arabic gum as a dispersing agent. FIG. 11 is a graph of the results of thermal gravimetric analysis (TGA) over the temperature range of about 90° C. to about 245° C. of copper flakes containing silver produced without the use of a dispersing agent and with the use of Daxad or Arabic gum as a dispersing agent. The use of Daxad 11G delays the oxidation of copper by about 30-40° C. The use of arabic gum consistently provided less oxidation that that was observed without the use of a dispersant over the temperature range of about 200° C. through 600° C.

### Electroless Plating

The electroless plating reactions were carried out in a 2 dm³ beaker under very strong stirring using a medium propeller at 1900 rpm.

After the displacement reaction was complete, the silver containing copper flakes (containing ˜14% Ag) were washed two times with water by settling. After the second water wash, 800 cm³ of DI water were added to the flakes and the temperature was raised to 75° C. A silver ammonia solution and a glucose solution were added separately, but at the same time, with strong stirring over 80 min to the heated dispersion of silver containing copper flakes. The silver ammonia solution was prepared by dissolving 34.11 g AgNO₃ (21.58 g Ag) in 23 cm³, adding 43.8 cm³ of NH₄OH 29% and adjusting the volume to 70 cm³. The glucose solution was prepared by dissolving 9.4 g D-glucose in 70 cm³ DI water. After the addition of the silver ammonia solution and the glucose solution was completed, the silver encased copper flakes were washed three times with DI H₂O and then twice with ethanol before being dried for 2 hours at 95° C.

### Use of Palladium Nitrate in Displacement Reaction

10.75 g of AgNO₃ (6.8 g Ag) was dissolved in 30 cm³ of DI H₂O. A solution of PdNO₃ was added in an amount to form a final solution having 0.1%, 0.5% or 1.0% Pd, based on the amount of silver. Each of these solutions was used to prepare copper flakes containing silver by displacement as described above. A solution without any Pd was also used. Copper flakes produced by the displacement reaction using Pd then had additional silver deposited on them using the electroless reaction as described above. The resulting silver coated copper flakes were then analyzed by FESEM and TGA.

FIGS. 13a-13d are FESEM images at a magnification of 100,000, of copper flakes with silver on the surface produced: (a) without the use of Pd, (b) using 0.1% P, (c) using 0.5% Pd, and (d) using 1.0% Pd. The size of the silver particles decreased with increasing concentrations of Pd used.

FIG. 14 is a graph of the results of thermal gravimetric analysis (TGA) over the temperature range of about 50° C. to about 600° C. of copper flakes containing silver produced: (a) without the use of Pd, (b) using 0.1% P, (c) using 0.5% Pd, and (d) using 1.0% Pd. The oxidation rate of copper was significantly slower when 1% Pd was used during the displacement reaction. The use of 0.5% Pd can provide some oxidation related benefit at temperatures from about 400° C. and above.

When silver coated copper flakes prepared using both the displacement and electroless reactions were placed in a 1M nitric acid solution, a blue color did not appear. This shows that the copper is not accessible to be dissolved by the acid and that the silver shell over the copper flakes is hermetically closed.

The preceding examples are intended only as illustrations; the following claims define the scope of the invention.

1. A composition comprising one or more copper flakes coated with silver, wherein the silver is present in a hermetically closed metal shell around the copper.

2. The composition of claim 1, wherein the grain size of silver in the deposited layer is about 40 nm or less, as measured by Field Emission Scanning Electron Microscopy (FESEM).

3. The composition of claim 1, wherein the grain size of silver in the deposited layer is about 15 nm or less, as measured by Field Emission Scanning Electron Microscopy (FESEM).

4. The composition of claim 1, further comprising palladium in an amount of about 1% or less by weight of silver in the shell.

5. The composition of claim 1, wherein the hermetically closed metal shell limits the oxidation of copper over a period of at least 365 days at a temperature of less than 100° C.

6. The composition of claim 1, wherein the copper flakes do not oxidize until they reach a temperature of at least 200° C.

7. The composition of claim 1, wherein the hermetically closed metal shell limits the migration of copper from the core flakes to the silver shell at temperatures below 250° C.

8. A method of manufacturing copper flakes coated with silver, the method comprising treating copper flakes with an acid to form acid treated copper flakes, treating the acid treated copper flakes with a polyamine to form polyamine treated copper flakes, depositing silver on the polyamine treated copper flakes to form copper flakes comprising silver deposits, and depositing silver onto the copper flakes comprising silver deposits wherein the polyamine is a mixture of linear polyamines with short and long chain lengths.

9. The method of claim 8, wherein the step of depositing silver on the polyamine treated copper flakes to form copper flakes comprising silver deposits is performed by electrodisplacement.

10. The method of claim 8, wherein the step of depositing silver onto the copper flakes comprising silver deposits is performed by electroless plating.

11. The method of claim 10, wherein the step of depositing silver onto the copper flakes comprising silver deposits by electroless plating uses a silver solution comprising a silver diamine complex.

12. The method of claim 10, wherein the step of depositing silver onto the copper flakes comprising silver deposits by electroless plating uses a sugar as a reducing agent.

13. The method of claim 11, wherein the step of depositing silver onto the copper flakes comprising silver deposits by electroless plating uses a sugar as a reducing agent.

14. The method of claim 12, wherein the sugar is dextrose or glucose.

15. The method of claim 13, wherein the sugar is dextrose or glucose.

16. The method of claim 8, wherein the polyamine is a mixture of triethylenetetramine (TETA) and ethylenediamine (EDA).

17. The method of claim 10, wherein the polyamine is a mixture of triethylenetetramine (TETA) and ethylenediamine (EDA).

18. The method of claim 13, wherein the polyamine is a mixture of triethylenetetramine (TETA) and ethylenediamine (EDA).

19. The method of claim 16, where the mixture of TETA/EDA is in a ratio 80/20 by weight.

20. The method of claim 18, where the mixture of TETA/EDA is in a ratio 80/20 by weight.

21. The method of claim 8, wherein the step of treating copper flakes with an acid to form acid treated copper flakes is performed in alcohol.

22. The method of claim 8, wherein the step of depositing silver on the polyamine treated flakes is performed in the presence of one or more dispersing agents.

23. The method of claim 22, wherein the dispersing agent comprises DAXAD 11D, Arabic gum, polyvinylpyrrolidone/PVP or sodium alginate.

24. The method as claimed in claim 22, wherein the step of depositing silver on the polyamine treated flakes is performed by adding an aqueous solution of silver salt to a mixture comprising the copper flakes, the polyamine and the dispersing agent.

25. The method as claimed in claim 24 wherein the silver salt is silver nitrate.

26. The method as claimed in claim 25 wherein the silver nitrate solution comprises 0.1 to 1.0% by weight palladium nitrate.

27. The method as claimed in claim 10 wherein the electroless plating comprises adding solutions of silver ammonia and dextrose separately, but at the same time, to a mixture comprising the copper flakes comprising silver deposits.

28. The method as claimed in claim 27 wherein the solutions of silver ammonia and dextrose are added to the mixture comprising the copper flakes comprising silver deposits over a period of about 2 hours at a temperature of approximately 75° C.

29. The method as claimed in claim 8 which is a method of manufacturing copper flakes coated with silver wherein the grain size of the silver in the deposited layer is about 40 nm or less, as measured by Field Emission Scanning Electron Microscopy (FESEM).

30. The method as claimed in claim 29 wherein the grain size of the silver in the deposited layer is about 15 nm or less, as measured by Field Emission Scanning Electron Microscopy (FESEM).
